(19) United States
(12) Patent Application Publication
(10) Pub. No.: US 2005/0049662 A1
(43) Pub. Date: Mar. 3, 2005

(54) Adjustable temperature heat patch

(75) Inventor: Ricky W. Purcell, Alpharetta, GA (US)

Correspondence Address: Schwegman, Lundberg, Woessner & Kluth, P.A., P.O. Box 2938, Minneapolis, MN, 55402, US

(73) Assignee: Kimberly-Clark Worldwide, Inc.

(21) Appl. No.: 10/650,407

(22) Filed: Aug. 27, 2003

(51) Int. Cl. A61H 1/02

(52) U.S. Cl. 607/114

(57) ABSTRACT

A heat patch that includes an enclosure made from a gas-permeable first layer and a second layer attached to the first layer. A heating composition is inside the enclosure. The heating composition generates heat when a gas (e.g., air) is received through the gas-permeable first layer. The gas-permeable first layer includes an inner surface and an outer surface. A gas-impermeable cover is detachably mounted to the outer surface of the first layer. In another aspect, the gas-impermeable cover includes a plurality of portions that are each detachably mounted to a separate area of the gas-permeable first layer. In still another aspect, the gas-impermeable cover includes information related to heat generated by the heat patch when the cover is removed from the gas-permeable first layer.

### FIELD

The present invention relates to a heat patch and more particularly to a heat patch that transfers heat to a human body when the heat patch is placed on or near the human body.

### BACKGROUND

A variety of heat-treating methods are used to treat symptoms such as stiffness, muscle pain, cold hands and feet, lumbago, rheumatism and neuralgia (among others). Some known heat-treating methods include direct application of heat to the body using items such as a towel, jelly and/or paste.

One concern with such heat-treating methods is controlling the amount of heat that is applied to the skin of the body. A burn could result if too much heat is applied to the skin. In addition, an individual may receive relatively ineffective therapy if too little heat is applied. Another concern with such heat-treating methods relates to their ability to apply heat for extended periods of time.

Another heat-treating method utilizes heat patches to apply heat to a body in order to treat any number of symptoms. One type of heat patch generates heat via an exothermic chemical reaction that takes place within the heat patch. Heat patches that generate heat using an exothermic reaction typically include an enclosure and a heating composition stored within the enclosure. At least a portion of the enclosure is air-permeable such that exposing the heat patch to air generates a heat-producing exothermic reaction within the heat patch.

Heat patches that generate heat with exothermic reactions are typically able to supply heat for significant periods of time but often lack sufficient temperature control. Some heat patches apply too much heat to the skin causing discomfort or burning while other heat patches apply insufficient heat generating minimal or no therapeutic effect.

Many heat patches are designed to establish a single target skin temperature for a specific length of time. The skin temperature and time are determined by the type and amount of heating composition in the heat patch and the amount of exposure of the heating composition to the air. These types of heat patches typically do not include the ability to adjust either the target heating temperature or heating time.

In addition, the enclosures typically include a heating composition at particular locations (i.e., pockets) within the enclosure. Therefore, exothermic reactions take place at only those locations causing heat to be generated locally within the heat patch instead of being distributed uniformly over the entire patch. The variation in amount of heat generated across such heat patches causes a user's skin to be heated to varying temperatures.

Accordingly, there is a need for a heat patch that uniformly applies heat to a particular area of the body. The heat patch should also be capable of maintaining a safe skin temperature for an extended period of time when the heat patch is applied to the body. There is also a need for a heat patch that allows a user or therapist to adjust the level of heat which is generated by the heat patch.

### SUMMARY OF THE INVENTION

The present invention relates to a heat patch that generates heat by an exothermic reaction which takes place within the heat patch. The rate of the exothermic reaction is easily controlled such that the temperature of the heat patch can be set by a user or therapist to one or more predetermined levels. In addition, if it is determined that the temperature of the heat patch is insufficient to provide the desired therapeutic effect, then the rate of the exothermic reaction can be increased without disturbing the placement of the heat patch. The heat patch is also easily manufactured and uniformly supplies heat over the entire heat patch for an extended period of time.

In one aspect, the present invention relates to a heat patch that includes an enclosure made from a gas-permeable first layer and a second layer attached to the first layer. A heating composition is sealed inside the enclosure. The heating composition generates heat when a gas (e.g., air) is received through the gas-permeable first layer. The gas-permeable first layer includes an inner surface and an outer surface. A gas-impermeable cover is detachably mounted to the outer surface of the first layer. Attaching the gas-impermeable cover to the outer surface of the gas-permeable first layer simplifies the number and type of components that are used to fabricate the heat patch making the heat patch less expensive to produce.

In another aspect, the present invention relates to a heat patch that includes an enclosure having a gas-permeable first layer and a second layer attached to the first layer. A heating composition is sealed inside the enclosure such that the heating composition generates heat when a gas (e.g., air) is received through the gas-permeable first layer. A gas-impermeable cover is attached to the gas-permeable first layer. The gas-impermeable cover includes a plurality of portions that are each detachably mounted to a separate area of the gas-permeable first layer. Mounting each of the plurality of portions that make up the cover to a different area on the gas-permeable first layer makes it easier for a user or therapist to remove particular portions and to customize the level of heat generated by the heat patch.

In still another aspect, the present invention relates to a heat patch that includes an enclosure having a gas-permeable first layer and a second layer attached to said first layer. A heating composition is sealed inside the enclosure in order to generate heat when a gas is received through the gas-permeable first layer. A gas-impermeable cover is attached to the gas-permeable first layer. The gas-impermeable cover includes information related to heat generated by the heat patch when the cover is removed from the gas-permeable first layer. Including heat-related information on the cover allows a user or therapist to select an appropriate temperature for the heat patch.

In yet another aspect, the present invention relates to a method of applying heat to a body. The method includes starting an exothermic reaction within a heat patch to generate heat. The heat patch includes an enclosure formed of a gas-permeable first layer and a second layer. The method further includes attaching the heat patch to or near the body and removing a cover from an outer surface of the gas-permeable first layer to increase the rate of the exothermic reaction.

In an alternative aspect, the method includes removing a portion of a cover from the gas-permeable first layer to increase the heat generated by the exothermic reaction. The cover is formed of a plurality of portions that are each detachably mounted to a separate area of the first layer. Removing selected portions of the cover from separate areas of the gas-permeable first layer allows a user or therapist to customize the level of heat generated by the exothermic reaction within the heat patch.

As an example, removing a portion of the cover from the gas-permeable first layer may generate sufficient heat to raise the temperature of the heat patch to a first target temperature (e.g., 39 degrees centigrade). In addition, the method may further include removing another portion of the cover from the gas-permeable first layer. Removing another portion of the cover may generate enough heat to raise temperature of the heat patch to a second target temperature (e.g., between 39 and 44 degrees centigrade).

In another alternative aspect, the method includes removing a cover from the gas-permeable first layer where the cover includes information as to heat generated by the exothermic reaction when the cover is removed from the gas-permeable first layer. Removing a cover from the gas-permeable first layer may include removing at least one of a plurality of portions that form the cover of the gas-permeable first layer.

In addition, removing at least one of a plurality of portions from the gas-permeable first layer may include (i) determining whether to increase the rate of the exothermic reaction; and/or (ii) analyzing information on at least one of the plurality of portions to determine which of the plurality of portions to remove from the gas-permeable first layer. Analyzing information relating to the plurality of portions may include analyzing alphanumeric information and/or colors on the plurality of portions.

The purposes and features of the present invention will be set forth in the description that follows. Additional features of the invention will be realized and attained by the product and processes particularly pointed out in the written description and claims hereof, as well as from the appended drawings.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention.

### BRIEF DESCRIPTION OF THE DRAWINGS

The present invention will be more fully understood, and further features will become apparent, when reference is made to the following detailed description and the accompanying drawings. The drawings are merely representative and are not intended to limit the scope of the claims. Like parts depicted in the drawings are referred to by the same reference numerals.

FIG. 1 illustrates a top view of a heat patch.

FIG. 2 illustrates a section view of the heat patch shown in FIG. 1 taken along line 2—2.

FIG. 3 illustrates a top view of another heat patch.

FIG. 4 illustrates a section view of the heat patch shown in FIG. 3 taken along line 4—4.

FIG. 5 illustrates a top view of another heat patch.

FIG. 6 illustrates a section view of the heat patch shown in FIG. 5 taken along line 6—6.

FIG. 7 illustrates a top view of still another heat patch.

FIG. 8 illustrates a top view of yet another heat patch.

### DETAILED DESCRIPTION OF THE INVENTION

In the following detailed description, reference is made to the accompanying drawings, which show specific embodiments in which the invention may be practiced. These embodiments are described in sufficient detail to enable those skilled in the art to practice the invention. It is to be understood that other embodiments may be utilized and structural changes made, such that the following detailed description is not to be taken in a limiting sense.

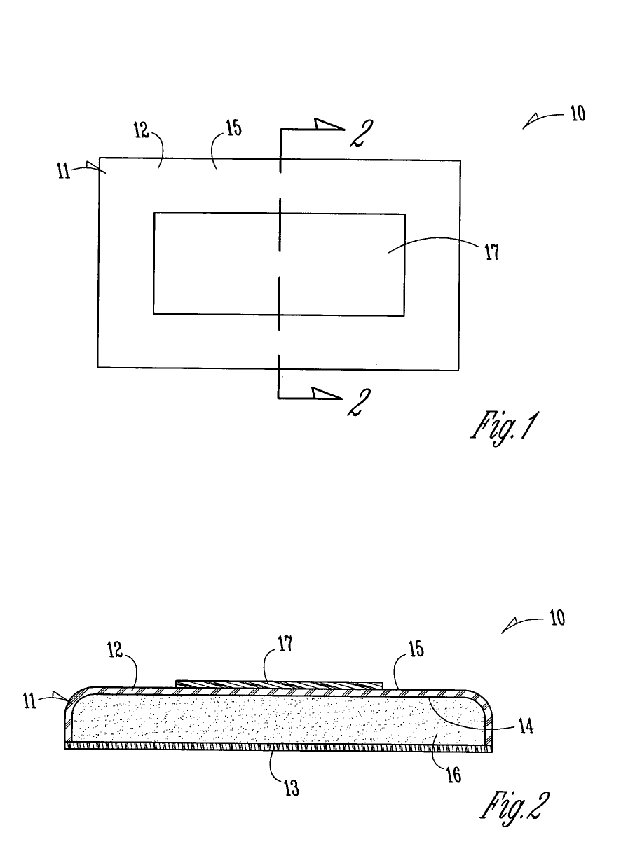

FIGS. 1 and 2 illustrate a heat patch 10. The heat patch 10 includes an enclosure 11 having a gas-permeable first layer 12 and a second layer 13 that is attached to the gas-permeable first layer 12. The gas-permeable first layer 12 includes an inner surface 14 and an outer surface 15.

A heating composition 16 (see FIG. 2) is sealed inside the enclosure 11. The heating composition 16 is capable of generating heat when a gas, such as oxygen contained in ambient air, is received through the gas-permeable first layer 12.

The heat patch 10 is stored in a hermetic environment (e.g., a sealed bag) such that the heating composition 16 remains unactivated until the heat patch 10 is removed from the hermetic environment. Heat patch 10 may be placed in the gas-tight sealed bag alone, or with additional heat patches that are part of a single piece which is folded for storage into the sealed bag. The individual patches could then be cut from the single piece before being applied on or near a body.

Once the heat patch 10 is removed from the hermetic environment and exposed to air, an exothermic reaction takes place. The exothermic reaction generates heat that causes the temperature of the heat patch 10 to rise. Increasing the rate at which the exothermic reaction takes place causes the temperature of the heat patch to rise, but reduces the duration of the exothermic reaction. The rate at which the exothermic reaction takes place is controlled by limiting the amount of air that feeds the exothermic reaction within the heat patch 10.

A gas-impermeable cover 17 is detachably mounted to the outer surface 16 of the gas-permeable first layer 12. The gas-impermeable cover 17 limits the amount of air that can pass through gas-permeable first layer 12. The extended duration of the exothermic reaction within the heat patch 10 maintains the temperature of the heat patch 10 at a predetermined level over a long period of time. The temperature of the heat patch 10 and length of heating time depend on how much of the gas-permeable first layer 12 is sealed by the gas-impermeable cover 17.

The second layer 13 of the enclosure 11 is used to apply heat (directly or indirectly) to part of a human body. The rate of the exothermic reaction is controlled such that the temperature of the second layer 13 rises to a desired level (e.g., between 38 and 44 degrees C). Elevating skin temperature any higher than 44 degrees C. for a long period of time can cause the skin to burn. In addition, elevating the skin temperature to less than 38 degrees C. typically has minimal therapeutic effect.

As an example, heat patch 10 may generate sufficient heat to raise the temperature of the enclosure 11 to around 38 degrees C. when the heat patch 10 is exposed to air and cover 17 is mounted on the outer surface 15 of gas-permeable first layer 12. If a user or therapist would like heat patch 10 to generate more heat, then cover 17 is removed from gas-permeable first layer 12 to expose the entire gas-permeable first layer 12 and raise the temperature of the enclosure to around 44 degrees C.

Attaching the gas-impermeable cover 17 directly to the outer surface 15 of the gas-permeable first layer 12 simplifies the number and type of components that are used to fabricate the heat patch 10 making the heat patch 10 less expensive to produce. Although the entire first layer 12 is shown as being gas-permeable, in some alternative forms, only certain section(s) of first layer 12 will be gas-permeable.

The second layer 13 is bonded around its perimeter to the perimeter of the gas-permeable first layer 12 by such means as adhesion, melt-bonding or sewing (among others). As an example, one edge of the joined gas-permeable first layer 12 and second layer 13 may be left open, and after the heating composition 16 is inserted, the open edge is sealed to form enclosure 11. The second layer 13 may be a polyethylene film (among other materials), and the gas-permeable first layer 12 may polyethylene, polypropylene and/or nylon nonwoven fabrics (among other materials).

Another example may include a layering approach in which a layer of heating composition 16 is deposited on the gas-permeable first layer 12. The gas-impermeable second layer 13 is then positioned on the heating composition 16 while the perimeter edges of the enclosure 11 are simultaneously sealed to entrap the heating composition 16.

Any conventional heating composition may be used to induce an exothermic reaction in the presence of a gas such as air. Some example heating compositions include iron powder as the main active ingredient.

Cover 17 includes an adhesive that engages the enclosure 11 on one side. The cover 17 may be polyethylene film or any material limits or blocks air-permeability.

In alternative forms, a release layer (not shown) may be detachably mounted to the second layer 13 using an adhesive. The release layer may be removed from the second layer 13 leaving only the adhesive on the second layer 13. The remaining adhesive provides a means for directly, or indirectly securing the heat patch 10 to a body.

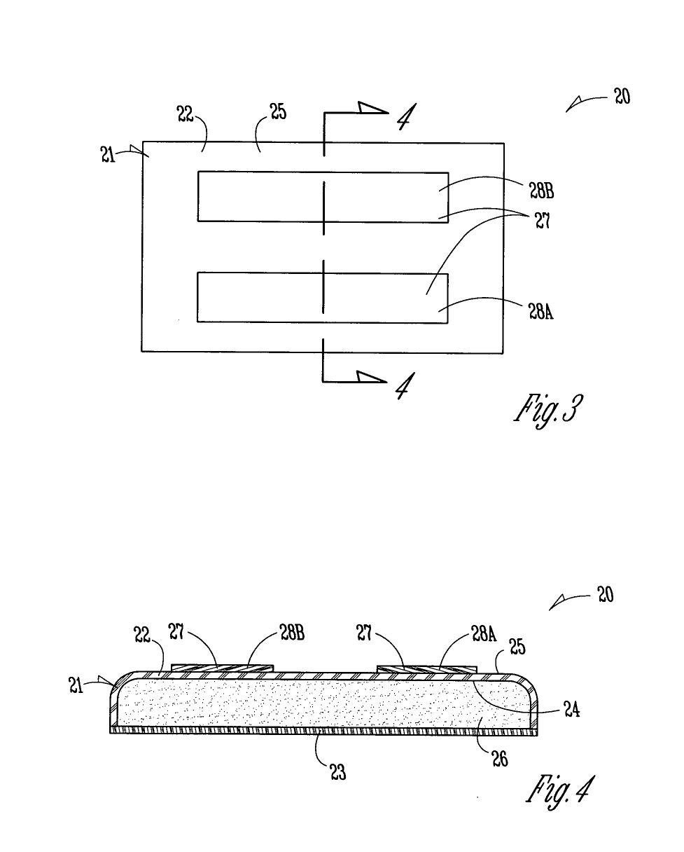

FIGS. 3 and 4 illustrate a heat patch 20. The heat patch 20 includes an enclosure 21 having a gas-permeable first layer 22 and a second layer 23 that is attached to the gas-permeable first layer 22. The gas-permeable first layer 22 includes an inner surface 24 and an outer surface 25. A heating composition 26 is sealed inside the enclosure 21. The heating composition 26 generates heat when a gas (e.g., air) is received through the gas-permeable first layer 22.

A gas-impermeable cover 27 is attached to the outer surface 25 of the gas-permeable first layer 22. The cover 27 includes a plurality of portions 28A, 28B that are each detachably mounted to separate areas of the gas-permeable first layer 22. In the example illustrated heat patch 20, the portions 28A, 28B are in the form of parallel strips. Mounting each of the plurality of portions 28A, 28B to a different area on the gas-permeable first layer 22 makes it easier for a user or therapist to remove particular portions and to customize the level of heat generated by the heat patch 20.

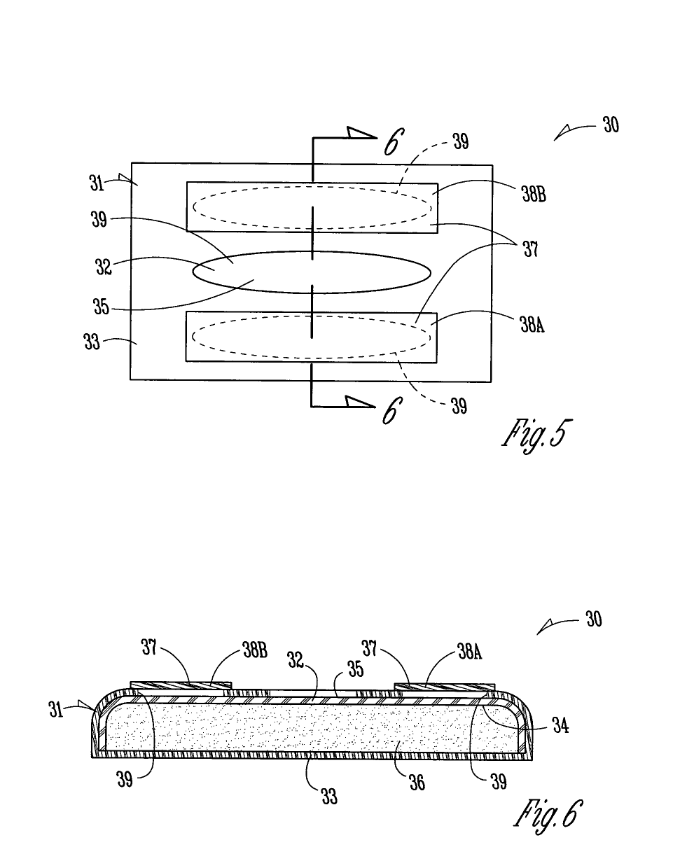

FIGS. 5 and 6 illustrate a heat patch 30. The heat patch 30 includes an enclosure 31 having a gas-permeable first layer 32 and a second layer 33 that is attached to the gas-permeable first layer 32. The gas-permeable first layer 32 includes an inner surface 34 and an outer surface 35.

A heating composition 36 is sealed inside the enclosure 31. The heating composition 36 generates heat when a gas (e.g., air) is received through the gas-permeable first layer 32.

In the illustrated example heat patch 30, second layer 33 is folded over gas-permeable first layer 32 onto the outer surface 35 of the gas-permeable first layer 32. The second layer 33 includes openings 39 such that portions of the gas-permeable first layer 32 are exposed by the openings 39. In other forms, a third layer (not shown) that includes openings may seal some of gas-permeable first layer 32

A gas-impermeable cover 37 is detachably mounted to the second layer 33. The cover 37 includes a plurality of portions 38A, 38B that are each detachably mounted to the second layer 33 such that the portions 38A, 38B seal at least some of the openings 39 in second layer 33. It should be noted that any number and arrangement of layers may be utilized as long the plurality of portions 38A, 38B seal different areas of the gas-permeable first layer 32.

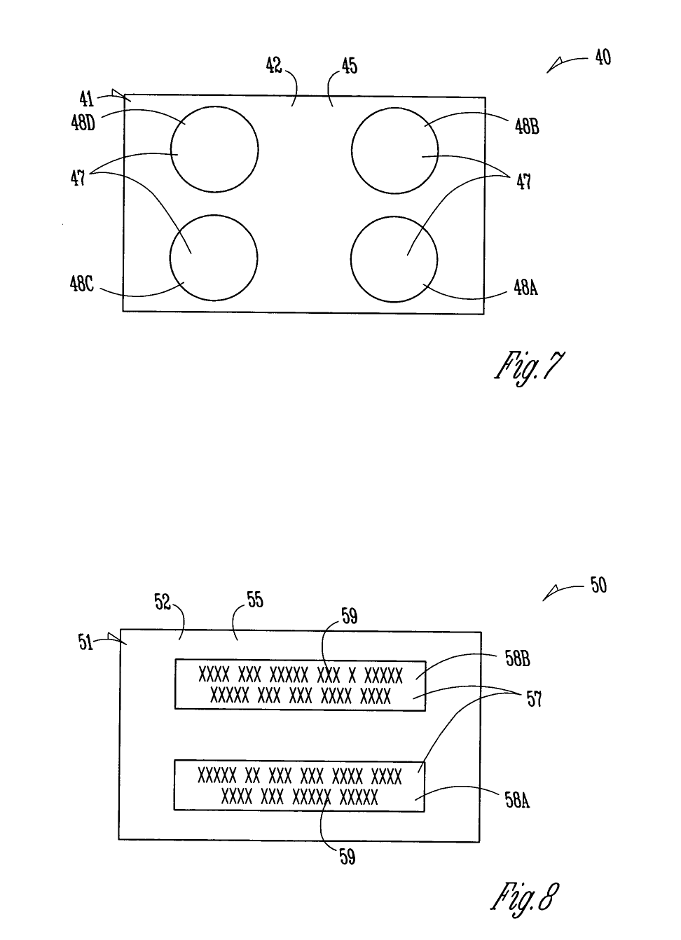

FIG. 7 illustrates a heat patch 40. The heat patch 40 includes an enclosure 41 having a gas-permeable first layer 42 and a second layer (not visible in FIG. 7) that is attached to the gas-permeable first layer 42. The gas-permeable first layer 42 includes an inner surface and an outer surface 45. A heating composition (not visible in FIG. 7) is sealed inside the enclosure 41. The heating composition generates heat when a gas (e.g., air) is received through the gas-permeable first layer 42.

A gas-impermeable cover 47 is detachably mounted to the outer surface 45 of the gas-permeable first layer 42. The cover 47 includes a plurality of portions 48A, 48B, 48C, 48D that are each detachably mounted to separate areas of the gas-permeable first layer 42. In the example illustrated heat patch 40, the portions 48A, 48B, 48C, 48D are circular. A comparison of the heat patch 40 shown in FIG. 7 with heat patches 10, 20, 30 shown in FIGS. 1, 3 and 5 demonstrates that the portions which are used to seal the gas-permeable first layer may vary in number, size and shape.

FIG. 8 illustrates a heat patch 50. The heat patch 50 includes an enclosure 51 having a gas-permeable first layer 52 and a second layer (not visible in FIG. 8) that is attached to the gas-permeable first layer 52. The gas-permeable first layer 52 includes an inner surface and an outer surface 55. A heating composition (not visible in FIG. 8) is sealed inside the enclosure 51 to generate heat when a gas (e.g., air) is received through the gas-permeable first layer 52.

The heat patch 50 further comprises a gas-impermeable cover 57 that includes information related to heat generated by the heat patch 50 when the cover 57 is removed from the gas-permeable first layer 52. The gas-impermeable cover 57 limits the amount of air that can pass through the gas-permeable first layer 52. Any type of information, including information related to the steady-state temperature of the heat patch 50 (with and/or without the cover 57 on heat patch 10), may be indicated on cover 57.

In the example heat patch 50 illustrated in FIG. 8, cover 57 includes a plurality of portions 58A, 58B that are detachably mounted to the gas-permeable second layer 52. Each of the portions 58A, 58B includes information related to heat generated by the heat patch when none, one, some or all of the portions 58A, 58B are removed from the gas-permeable first layer 52. In alternative forms, only one of the portions 58A, 58B includes information related to the steady-state temperature of the heat patch 50.

As an example, heat patch 50 may generate sufficient heat to raise the enclosure 51 temperature to around 38 degrees C. when the heat patch 50 is exposed to air and each of the portions 58A, 58B is mounted on outer surface 55. One or more of the portions 58A, 58B may include alphanumeric information 59 such as “REMOVING ONE COVER RAISES THE TEMPERATURE OF THIS HEAT PATCH TO 41 DEGREES C. & REMOVING BOTH COVERS RAISES THE TEMPERATURE OF THIS HEAT PATCH TO 44 DEGREES C.”

Therefore, when a user or therapist would like heat patch 50 to operate at a steady-state temperature of 41 degrees C., they know to remove one of portions 58A, 58B from gas-permeable first layer 52. In addition, when a user or therapist would like heat patch 50 to operate at a steady-state temperature of 44 degrees C., they know to remove both portions 58A, 58B from gas-permeable first layer 52.

Although FIG. 8 illustrates using alphanumeric information on portions 58A, 58B, information can be provided on one or more of the portions 58A, 58B in any form, including color-coding, bar coding or any other means of conveying information. As an example, a cover may include multiple portions with at least some of the portions being different colors where the different colors indicate information related to heat generated by the heat patch when one or more of the portions are removed from the gas-permeable first layer. In addition, the type of information may vary as long as the cover (or portions that form the cover) provides information relating to heat generated by the heat patch with and/or without removing the cover. It should be noted that information could also be located on the enclosure under one or more covers so that the information is exposed once the cover(s) are removed.

A method of applying heat to a body is described herein with reference to FIGS. 1-2. In one form, the method includes starting an exothermic reaction within a heat patch 10 to generate heat. The heat patch includes an enclosure 11 formed of a gas-permeable first layer 12 and a second layer 13. The method further includes attaching the heat patch 10 to or near the body and optionally removing a cover 17 from an outer surface 15 of the gas-permeable first layer 12 to increase a rate of the exothermic reaction. Starting an exothermic reaction within the heat patch 10 may include exposing the heat patch 10 to air.

Another form of the method of applying heat to a body is described herein with reference to FIGS. 3-4. The method includes starting an exothermic reaction within a heat patch 20 to generate heat. The heat patch 20 includes an enclosure 21 formed of a gas-permeable first layer 22 and a second layer 23. The method further includes attaching the heat patch 20 to or near the body and removing none, one or more portions 28A, 28B of a cover 27 from the gas-permeable first layer 22 to increase a rate of the exothermic reaction. The cover 27 is formed of a plurality of portions 28A, 28B that are each detachably mounted to a separate area of the gas-permeable first layer 22.

In some sample forms of the method, removing a portion 28A or 28B of the cover 27 from the gas-permeable first layer generates enough heat to maintain the second layer 23 at 41 degrees centigrade. The method may further include removing another portion 28A or 28B of the cover 27 from the gas-permeable first layer 22 to further increase the rate of the exothermic reaction and maintain the second layer 23 at 44 degrees centigrade. It should be noted that in other forms of the method any number, type or combination of the portions that form a cover may be removed from the gas-permeable first layer (see e.g., FIG. 7).

Another form of the method of applying heat to a body is described herein with reference to FIG. 8. The method includes starting an exothermic reaction within a heat patch 50 to generate heat. The heat patch 50 includes an enclosure 51 that is formed of a gas-permeable first layer 52 and a second layer (not visible in FIG. 8). The method further includes removing a cover 57 from the gas-permeable first layer 52. The cover 57 includes information as to the level of heat generated by the exothermic reaction when the cover 57 is removed from the gas-permeable first layer 52.

In some sample forms of the method, removing the cover 57 from the gas-permeable first layer 52 may include removing at least one of a plurality of portions 58A, 58B that form the cover 57 from the gas-permeable first layer 52. One, some or all of the plurality of portions 58A, 58B may include information as to the level of heat generated by the exothermic reaction when one or more of the plurality of portions 58A, 58B are removed from the gas-permeable first layer 52.

In addition, removing at least one of the portions 58A, 58B from the gas-permeable first layer 52 may include (i) determining whether to increase the rate of the exothermic reaction; and/or (ii) analyzing information on at least one of the portions 58A, 58B to determine which portion 58A, 58B to remove from the gas-permeable first layer 52. Analyzing information on each of the plurality of portions 58A, 58B may include analyzing alphanumeric information and/or colors on the plurality of portions 58A, 58B. As discussed above, the number and type of portions that form a cover can vary such that the information on the portions that form the cover will depend on the number and/or type of portions and the application where the heat patch will be used (among other factors).

The operations discussed above with respect to the described methods may be performed in a different order from those described herein. It should be noted that attaching a heat patch to a body includes attaching the heat patch directly or indirectly to the body. In addition, FIGS. 1-8 are representational and are not necessarily drawn to scale. Certain proportions thereof may be exaggerated, while others may be minimized.

The heat patches and methods described herein allow a user or therapist to more easily control the temperature of a heat patch over a long period of time. The heat patches and methods are also easily manufactured and effective in distributing heat uniformly across the entire heat patch.

While the invention has been described in detail with respect to the specific aspects thereof, it will be appreciated that those skilled in the art, upon attaining an understanding of the foregoing, may readily conceive of alterations to, variations of, and equivalents to these aspects which fall within the spirit and scope of the present invention, which should be assessed accordingly to that of the appended claims.

1. A heat patch comprising:
an enclosure that includes a gas-permeable first layer and a second layer attached to said gas-permeable first layer, said gas-permeable first layer including an inner surface and an outer surface;
a heating composition inside said enclosure, said heating composition being capable of generating heat when a gas is received through said gas-permeable first layer; and
a gas-impermeable cover that is detachably mounted to said outer surface of said gas-permeable first layer.

2. The heat patch of claim 1 wherein said heating composition comprises iron powder, water, water retaining agent, reaction promoter and salt.

3. The heat patch of claim 1 wherein said entire first layer is gas-permeable.

4. The heat patch of claim 1 wherein said gas-permeable first layer is polyethylene.

5. The heat patch of claim 1 wherein said second layer is polyethylene film.

6. The heat patch of claim 1 wherein said gas-impermeable cover is polyethylene film.

7. The heat patch of claim 1 wherein said heating composition is capable of generating heat when air is received through said gas-permeable first layer.

8. The heat patch of claim 1 wherein said gas-impermeable cover includes a plurality of portions detachably mounted to said outer surface of said gas-permeable first layer.

9. The heat patch of claim 8 wherein said plurality of portions seal some of said gas-permeable first layer such that said heating composition generates heat which maintains said second layer at between about 38 and 40 degrees centigrade when the heat patch is exposed to the gas.

10. The heat patch of claim 9 wherein said heat composition maintains said second layer at between about 40 and 42 degrees centigrade when at least one of said plurality of portions is removed from said gas-permeable first layer.

11. The heat patch of claim 10 wherein said heat composition maintains said second layer at between about 42 and 44 degrees centigrade when all of said plurality of portions are removed from said gas-permeable first layer.

12. The heat patch of claim 8 wherein said plurality of portions include strips that seal some of said gas-permeable first layer.

13. The heat patch of claim 8 wherein at least one of said plurality of portions includes information related to heat generated by the heat patch when one or more of said plurality of portions is removed from said gas-permeable first layer.

14. The heat patch of claim 13 wherein at least some of said plurality of portions are different colors, the colors supplying said information related to heat generated by the heat patch when one or more of said plurality of portions is removed from said gas-permeable first layer.

15. A heat patch comprising:
an enclosure that includes a gas-permeable first layer and a second layer attached to said gas-permeable first layer;
a heating composition inside said enclosure, said heating composition capable of generating heat when a gas is received through said gas-permeable first layer; and
a gas-impermeable cover that includes a plurality of portions, each of said plurality of portions being detachably mounted to a separate area of said gas-permeable first layer.

16. The heat patch of claim 15 wherein each of said plurality portions are similarly sized.

17. The heat patch of claim 15 wherein said entire first layer is gas-permeable.

18. The heat patch of claim 15 wherein said plurality of portions are strips.

19. A heat patch comprising:
an enclosure that includes a gas-permeable first layer and a second layer attached to said first layer;
a heating composition inside said enclosure, said heating composition capable of generating heat when a gas is received through said gas-permeable first layer; and
a gas-impermeable cover that includes information related to heat generated as a result of removing said gas-impermeable cover from said gas-permeable first layer and exposing the heat patch to the gas.

20. The heat patch of claim 19 wherein said gas-impermeable cover includes a plurality of portions that are detachably mounted to said gas-permeable first layer.

21. The heat patch of claim 20 wherein at least one of said plurality of portions includes information related to heat generated by the heat patch when one or more of said plurality of portions is removed from said gas-permeable first layer.

22. The heat patch of claim 21 wherein at least one of said plurality of portions include alphanumeric information related to heat generated by the heat patch when one or more of said plurality of portions is removed from said gas-permeable first layer.

23. The heat patch of claim 21 wherein some of said plurality of portions are different colors, the different colors indicating said information related to heat generated by the heat patch when one or more of said plurality of portions is removed from said gas-permeable first layer.

24. The heat patch of claim 19 wherein said enclosure includes information related to heat generated by the heat patch when said gas-impermeable cover is removed from said gas-permeable first layer, said information on said enclosure being exposed when said gas-impermeable cover is removed from said gas-permeable first layer.

25. A method of applying heat to a body, the method comprising:
starting an exothermic reaction within a heat patch to generate heat, the heat patch including an enclosure formed of a gas-permeable first layer and a second layer;
attaching the heat patch to the body; and
removing a cover from an outer surface of the gas-permeable first layer to increase a rate at which heat is generated by the exothermic reaction.

26. The method of claim 25 wherein starting an exothermic reaction within the heat patch includes exposing the heat patch to air.

27. The method of claim 25 wherein removing a cover from the gas-permeable first layer includes removing at least one of a plurality of portions that form the cover from the outer surface of the gas-permeable first layer.

28. A method of applying heat to a body, the method comprising:
starting an exothermic reaction within a heat patch to generate heat, the heat patch including an enclosure formed of a gas-permeable first layer and a second layer;
attaching the heat patch to the body; and
removing a portion of a cover from the gas-permeable first layer to increase a rate at which the heat generated by the exothermic reaction, the cover being formed of a plurality of portions that are each detachably mounted to a separate area of the first layer.

29. The method of claim 28 wherein removing a portion of the cover from the gas-permeable first layer generates heat that maintains the second layer at a temperature between about 40 and 42 degrees centigrade.

30. The method of claim 28 further comprising removing another portion of the cover from the gas-permeable first layer to increase the rate at which heat is generated by the exothermic reaction.

31. The method of claim 30 wherein removing another portion of the cover from the gas-permeable first layer generates heat that maintains the second layer at a temperature between about 42 and 44 degrees centigrade.

32. A method of applying heat to a body, the method comprising:
starting an exothermic reaction within a heat patch to generate heat, the heat patch including an enclosure formed of a gas-permeable first layer and a second layer;
attaching the heat patch to the body; and
removing a cover from the gas-permeable first layer, the cover including information relating to heat generated by the exothermic reaction when the cover is removed from the gas-permeable first layer.

33. The method of claim 32 wherein removing a cover from the gas-permeable first layer includes removing at least one of a plurality of portions that form the cover from the gas-permeable first layer, at least one of the plurality of portions including information as to heat generated by the exothermic reaction when one or more of the plurality of portions is removed from the gas-permeable first layer.

34. The method of claim 33 wherein removing at least one of a plurality of portions from the gas-permeable first layer includes determining whether to increase the rate of the exothermic reaction, and analyzing information on at least one of the plurality of portions to determine which of the plurality of portions to remove from the gas-permeable first layer.

35. The method of claim 34 wherein analyzing information on each of the plurality of portions includes analyzing alphanumeric information.

36. The method of claim 34 wherein analyzing information on each of the plurality of portions includes analyzing colors on the plurality of portions.

37. The method of claim 32 wherein removing the cover from the gas-permeable first layer includes exposing information on the gas-permeable first layer relating to heat generated by the exothermic reaction when the cover is removed from the gas-permeable first layer.
